(19) United States
(12) Patent Application Publication
(10) Pub. No.: US 2023/0281430 A1
(43) Pub. Date: Sep. 7, 2023

(54) CONDITIONING GRAPH NEURAL NETWORKS ON GRAPH AFFINITY MEASURE FEATURES

(71) Applicant: Google LLC, Mountain View, CA (US)

(72) Inventors: Ali Kemal Sinop, Fremont, CA (US); Sreenivas Gollapudi, Cupertino, CA (US); Petar Velickovic, Cambridge (GB); Sofia Ira Ktena, London (GB); Ameya Avinash Velingker, Orefield, PA (US)

(21) Appl. No.: 18/118,061

(22) Filed: Mar. 6, 2023

(30) Foreign Application Priority Data
Mar. 4, 2022 (GR) 20220100211

(51) Int. Cl. G06N 3/047; G06N 3/082

(52) U.S. Cl. CPC G06N 3/047; G06N 3/082

(57) ABSTRACT

Methods and systems for conditioning graph neural networks on affinity features. One of the methods includes obtaining graph data representing an input graph that comprises a set of nodes and a set of edges that each connect a respective pair of nodes, the graph data comprising respective node features for each of the nodes, edge features for each of the edges, and a respective weight for each of the edges; generating one or more affinity features, each affinity feature representing a property of one or more random walks through the graph guided by the respective weights for the edges; and processing the graph data using a graph neural network that is conditioned on the one or more affinity features to generate a task prediction for a machine learning task for the input graph.

### CROSS-REFERENCE TO RELATED APPLICATION

This disclosure claims priority to Greek Application No. 20220100211, entitled, “Conditioning Graph Neural Networks on Graph Affinity Measure Features,” and filed on Mar. 4, 2022. The disclosure of the prior application is considered part of and is incorporated by reference in the disclosure of this application.

### BACKGROUND

This specification relates to processing graph data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that processes graph data representing an input graph using a graph neural network to generate a task prediction.

Prior to processing the graph data using the graph neural network, the system generates a set of one or more affinity features. Each affinity feature represents a respective property of one or more random walks from one node to another node in the graph guided by the weights for the edges in the graph. Examples of affinity features include effective resistance features, hitting time features, commute time features, and resistive embeddings.

The system then processes the graph data using the graph neural network while the graph neural network is conditioned on the one or more affinity features to generate the task prediction.

Particular embodiments of the subject matter described in this specification can be implemented so as to realize one or more of the following advantages.

This specification describes conditioning a graph neural network on affinity features of an input graph in order to generate a task prediction for the input graph. Affinity features are features that represent a property of one or more random walks through the graph. By conditioning the graph neural network on these features, the graph neural network can generate more accurate task predictions. For example, a graph neural network with significantly fewer graph neural network layers, i.e., significantly fewer message passing steps, can, when conditioned on the affinity features, generate more accurate predictions than a graph neural network with significantly more graph layers that is not conditioned on the affinity features. Thus, task predictions can be generated in a much more computationally efficient manner and while consuming fewer processor cycles and requiring fewer memory reads.

More specifically, graph neural networks generally perform a relatively limited number of message passing and hence inherently have a smaller receptive field. Incorporating affinity features into the processing improves the expressivity of the graph neural network and compensates for the smaller receptive field by incorporating structural aspects of the underlying graph. This results in an architecture that has lower computational complexity and allows the network to exploit the connectivity properties of the graph using features that are invariant to permutations of the underlying graph. This allows the described approach to outperform relevant benchmarks for a wide variety of tasks, often with significantly fewer message passing steps.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example graph processing system.

FIG. 2 is a flow diagram of an example process for processing graph data.

FIG. 3 is a flow diagram of an example process for generating a hitting time feature for a given edge.

FIG. 4 is a flow diagram of an example process for generating a commute time feature for a given edge.

FIG. 5 is a flow diagram of an example process for determining respective resistive embeddings for the nodes of the graph.

Like reference numbers and designations in the various drawings indicate like elements.

### DETAILED DESCRIPTION

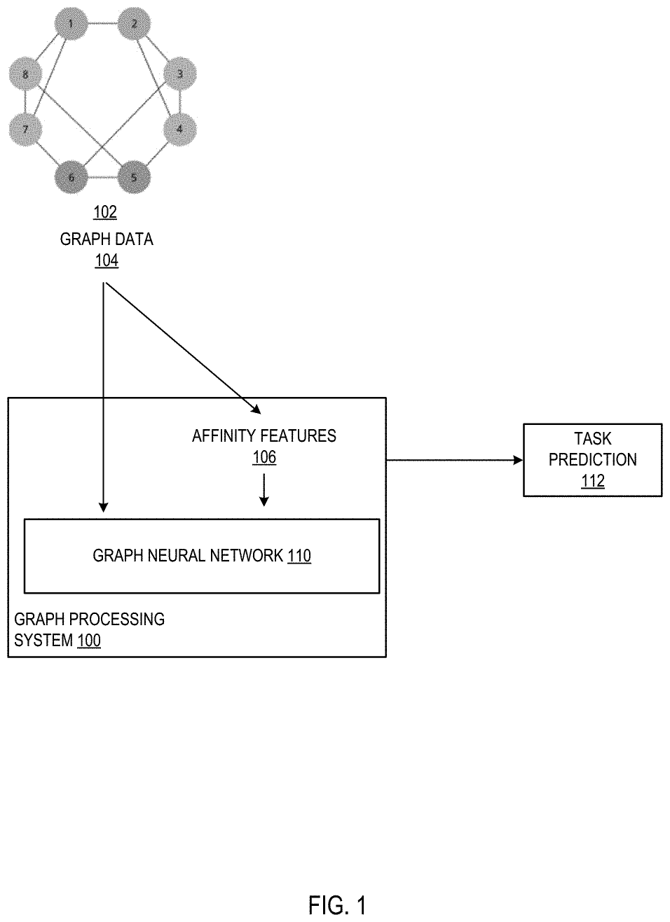

FIG. 1 shows an example graph processing system 100. The graph processing system 100 is an example of a system implemented as computer programs on one or more computers in one or more locations in which the systems, components, and techniques described below are implemented.

The system 100 processes graph data 102 representing an input graph 104 using a graph neural network 110 to generate a task prediction 112.

The graph 104 includes a set of nodes and a set of edges that each connect a respective pair of nodes. In the example of FIG. 1, the graph 104 includes eight nodes and each node is connected by an edge to each other node. However, more generally, the graph 104 can include any number of nodes and not all of the nodes need to be connected by edges.

Each edge is associated with a weight. In some cases, the graph 104 is an unweighted graph and the weights are all equal to one. In some other cases, different edges can have different weights.

Generally, the graph 104 can represent a set of entities, i.e., such that each entity is represented by a respective node in the graph, and the task prediction 112 can be any appropriate prediction characterizing one or more of the entities.

The task prediction 112 can be, e.g., a classification prediction, or a regression prediction. A classification prediction can include a respective score for each class in a set of possible classes, where the score for a class can define a likelihood that the set of entities represented by the graph are included in the class. A regression prediction can include one or more numerical values, each drawn from a continuous range of values, that characterize the set of entities represented by the graph 104.

The system 100 described herein is widely applicable and is not limited to one specific implementation. However, for illustrative purposes, a small number of example implementations are described below.

In some implementations, the graph can represent a molecule, each node in the graph can represent a respective atom in the molecule, and the task prediction can characterize one or more predicted properties of the molecule, e.g., the equilibrium energy of the molecule, the energy required to break up the molecule, the charge of the molecule, a biological function of the molecule, e.g., whether the molecule inhibits virus replication or not, a biological activities classification for the molecule, or a quantum-chemical property of the molecule, e.g., the HOMO-LUMO gap of the molecule.

In some implementations, the graph can represent a physical system, each node in the graph can represent a respective object in the physical system, and the task prediction can characterize a respective predicted future state of one or more objects in the physical system, e.g., a respective position and/or velocity of each of one or more objects in the physical system at a future time point.

In some implementations, the graph can represent a point cloud (e.g., generated by a lidar or radar sensor), each node in the graph can represent a respective point in the point cloud, and the task prediction can predict a class of object represented by the point cloud.

In some implementations, the graph can represent a portion of text, each node in the graph can represent a respective word in the portion of text, and the task prediction can predict, e.g., a sentiment expressed in the portion of text, e.g., positive, negative, or neutral.

In some implementations, the graph can represent an image, each node in the graph can represent a respective portion of the image (e.g., a pixel or a region of the image), and the task prediction can characterize, e.g., a class of object depicted in the image.

In some implementations, the graph can represent an environment in the vicinity of a partially- or fully-autonomous vehicle, each node in the graph can represent a respective agent in the environment (e.g., a pedestrian, bicyclist, vehicle, etc.) or an element of the environment (e.g., traffic lights, traffic signs, road lanes, etc.), and the task prediction can predict, e.g., a respective future trajectory of one or more of the agents represented by nodes in the graph. For example, the prediction output can characterize a respective likelihood that a vehicle agent represented by a node in the graph will make one or more possible driving decisions, e.g., going straight, changing lanes, turning left, or turning right. In this example, to predict a future trajectory of an agent represented by a node in the graph, the system can process the update node embedding for only the node representing the agent, i.e., without processing the updated node embeddings for the other nodes in the graph.

In some implementations, the graph can represent a social network (e.g., on a social media platform), each node in the graph can represent a respective person in the social network, each edge in the graph can represent, e.g., a relationship between two corresponding people in the social network (e.g., a “follower” or “friend” relationship), and the task prediction can predict, e.g., which people in the social network are likely to perform a certain action in the future (e.g., purchase a product or attend an event).

In some implementations, the graph can represent a road network, each node in the graph can represent a route segment in the road network, each edge in the graph can represent that two corresponding route segments are connected in the road network, and the task prediction can predict, e.g., a time required to traverse a specified path through the road network.

In some implementations, the graph can be a computational graph that represents, e.g., computational operations performed by a neural network model, each node in the graph can represent a group of one or more related computations (e.g., operations performed by a group of one or more neural network layers), and each edge in the graph can represent that an output of one group of computations is provided as an input to another group of computations. In these implementations, the task prediction can predict, e.g., a respective computing unit (i.e., from a set of available computing units) that should perform the operations corresponding to each node in the graph, e.g., to minimize a time required to perform the operations defined by the graph. Each computing unit can be, e.g., a respective thread, central processing unit (CPU), or graphics processing unit (GPU).

In some implementations, the graph can represent a protein, each node in the graph can represent a respective amino acid in the amino acid sequence of the protein, and each edge in the graph can represent that two corresponding amino acids in the protein are separated by less than a threshold distance (e.g., 8 Angstroms) in a structure of the protein. In these implementations, the task prediction can predict, e.g., a stability of the protein, or a function of the protein.

As used throughout this specification, a “graph” refers to a data structure that includes at least: (i) a set of nodes, and (ii) a set of edges. Each edge in the graph can connect a pair of nodes in the graph. The graph can be a “directed” graph, i.e., such that each edge that connects a pair of nodes is defined as pointing from the first node to the second node or vice versa, or an “undirected” graph, i.e., such that the edges are not associated with directions.

Data defining a graph can include data defining the nodes and the edges of the graph, and can be represented in any appropriate numerical format. For example, a graph can be defined by an adjacency matrix that includes a number of rows and a number of columns equal to the number of nodes in the graph. Each entry (i,j) in the adjacency matrix can have value 1 (or some other predefined value) if the graph includes an edge connecting node i and node j, and value 0 (or some other predefined value) otherwise. As another example, a graph can be defined by a set of tuples {(i,j)}, where each tuple (i,j) represents an edge in the graph connecting the node i and node j.

As used throughout this specification, an “embedding” refers to an ordered collection of numerical values, e.g., a vector, matrix, or other tensor of numerical values.

Prior to processing the graph data 102 using the graph neural network 110, the system 100 generates a set of one or more affinity features 106.

Each affinity feature 106 represents a respective property of one or more random walks from one node to another node in the graph 104 guided by the weights for the edges in the graph 104. Examples affinity features include effective resistance features, hitting time features, commute time features, and resistive embeddings.

Affinity features and computing affinity features are described in more detail below.

The system 100 then processes the graph data 104 using the graph neural network 110 while the graph neural network 110 is conditioned on the one or more affinity features 106 to generate the task prediction 112.

The system 100 can condition the graph neural network 110 on the one or more affinity features in any of a variety of ways.

As one example, the system 100 can modify the node features, the edge features, or both using the affinity features to generate modified graph data and then process the modified graph data using the graph neural network. For example, the system 100 can concatenate, to the edge features of each edge in the graph, one or more of: an effective resistance feature for the edge, a hitting time feature for the edge, or a commute time feature for the edge. As another example, the system 100 can concatenate to the node features of each node in the graph 104 a resistive embedding feature for the node.

As another example, the system 100 can modify the graph data 102 to add new features for one or more new nodes, one or more new edges, or both in the graph 104 using the affinity features 106 to generate modified graph data and then process the modified graph data using the graph neural network 110.

As yet another example, the system 100 can modify the operations performed by one or more of the graph neural networks layers in the graph neural network 110 using the affinity features 106. For example, the message passing function applied by one or more of the graph layers can be modulated based on the affinity features.

The graph neural network 110 can have any appropriate graph neural network (GNN) architecture that allows the graph neural network 110 to map the graph data 102 to a task prediction 112.

For example, the graph neural network 110 can include respective encoders, e.g., MLPs, that encode the node features, the edge features, and, when included, the graph-level features to generate respective encoded features.

The graph neural network 110 can then include one or more graph neural network layers. Each graph neural network layer receives as input the current node features, the current edge features, and, when included, the current graph-level features and then updates the current node features, the current edge features, and, when included, the current graph-level features by performing message passing. The graph layers can apply any of a variety of message passing techniques to update the current features. Examples include those employed by Graph Attention Networks, Message Passing Neural Networks, Graph Convolutional Networks, and so on.

After the last graph layer, the graph neural network 110 can then apply one or more decoder neural networks to generate the task predictions. For example, for tasks that require a prediction about an edge in the graph, the graph neural network can process the updated edge features for the edge using an edge decoder neural network. As another example, for tasks that require a prediction about a node in the graph, the graph neural network can process the updated node features for the node using a node decoder neural network. As another example, for tasks that require a graph-level prediction about the entire graph, the graph neural network can process the updated graph-level features (or a combination of, e.g., a sum, average, or pooling operation, of the updated node features, updated edge features, or both) using a graph decoder neural network.

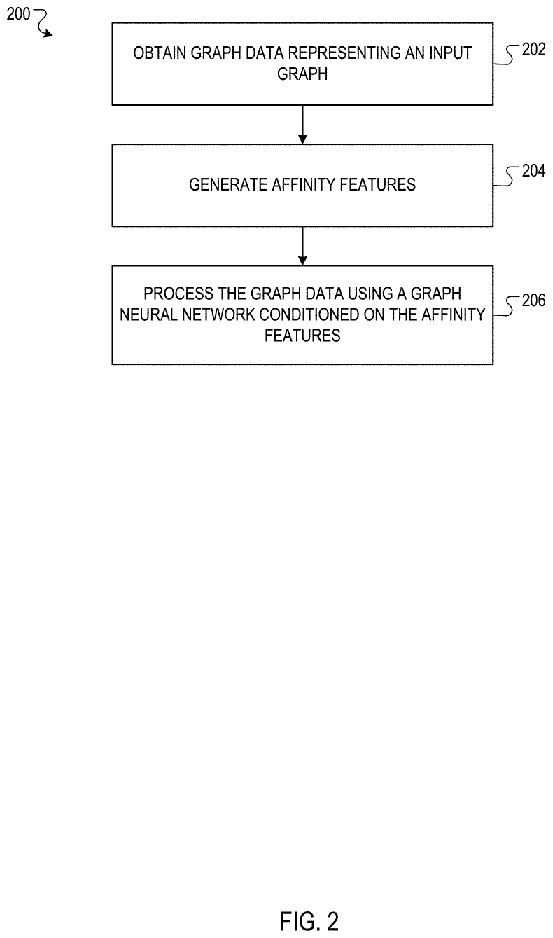

FIG. 2 is a flow diagram of an example process 200 for processing graph data to generate a task prediction. For convenience, the process 200 will be described as being performed by a system of one or more computers located in one or more locations. For example, a graph processing system, e.g., the graph processing system 100 of FIG. 1, appropriately programmed in accordance with this specification, can perform the process 200.

The system obtains graph data representing an input graph (step 202). As described above, the input graph includes a set of nodes and a set of edges that each connect a respective pair of nodes and the graph data includes respective node features for each of the nodes, edge features for each of the edges, and a respective weight for each of the edges. Optionally, the graph data can also include graph-level features that represent the entire graph. Each set of features, i.e., the graph-level features, the node features for a given node, and the edge features for a given edge, is generally represented as a vector of numerical values.

The system generates one or more affinity features for the graph (step 204).

Each affinity feature represents a property of one or more random walks through the graph guided by the respective weights for the edges. A random walk through a graph is a process that begins at one node in the graph and at each step moves to another node in the graph that is connected by an edge to the current node. When the current node is connected to multiple nodes by edges, the likelihood that the walk moves to each of the multiple nodes is defined by the weights for the corresponding edges. That is, the walk moves to a neighbor node with probability proportional to the weight of the corresponding edge that connects the current node to a neighbor node. For example, the probability can be equal to the weight for the corresponding edges divided by the sum of the weights for all edges connecting the current node to other nodes.

The affinity features can include any of one or more types of features that each measure a respective property of a random walk.

For example, the affinity features can include a respective hitting time feature for each of one or more of the edges in the graph. The hitting time feature for a given edge in the graph represents an expected number of steps for a random walk starting at a first node in the respective pair connected by the edge to hit a second node in the respective pair connected by the edge.

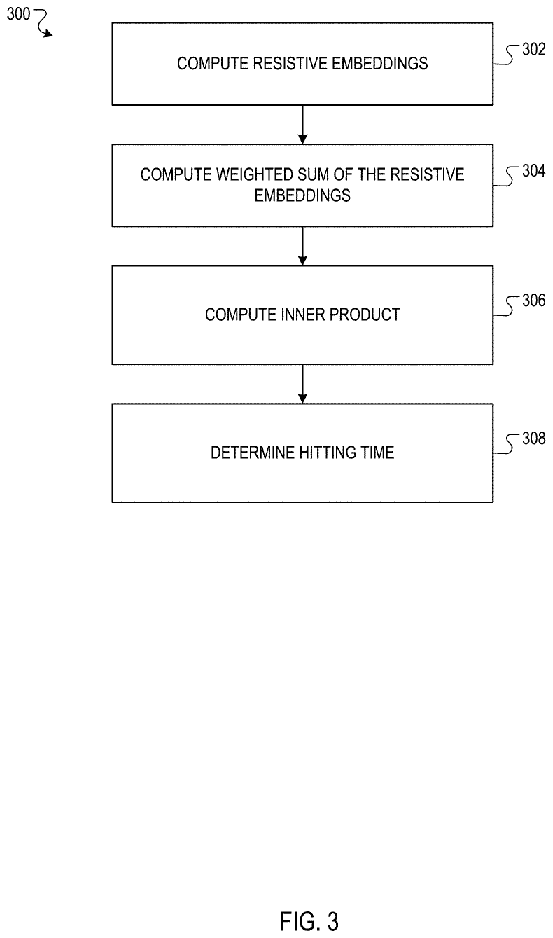

An example technique for computing the hitting time feature for a given edge is described below with reference to FIG. 3.

As another example, the affinity features can include a respective commute time feature for each of one or more of the edges in the graph. The commute time feature for a given edge in the graph represents an expected number of steps for a random walk starting at a first node in the respective pair connected by the edge to reach a second node in the respective pair connected by the edge and then return to the first node in the respective pair connected by the edge.

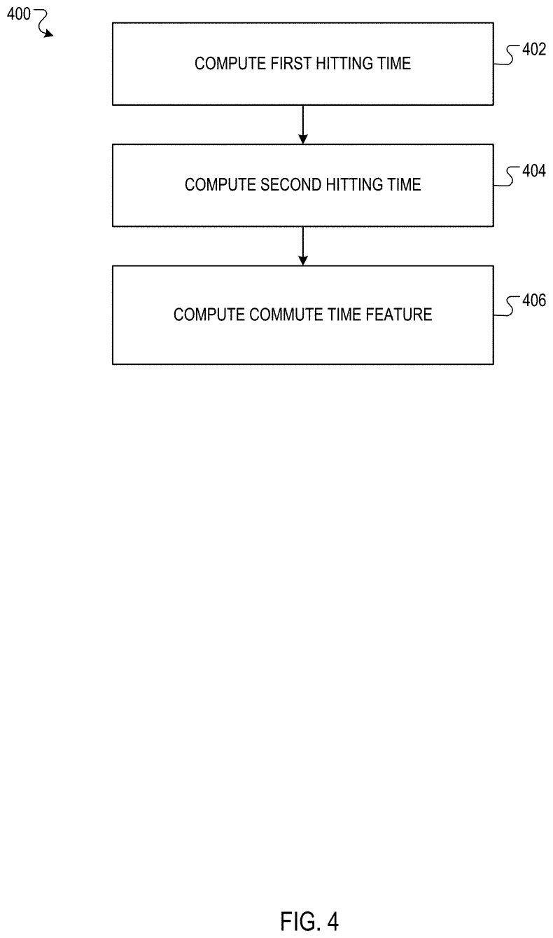

An example technique for computing the commute time feature for a given edge is described below with reference to FIG. 4.

As another example, the one or more affinity features can include an effective resistance feature for each of one or more of the edges in the graph. The effective resistance feature for a given edge represents an effective resistance between a first node in the respective pair connected by the edge and a second node in the respective pair connected by the edge in a circuit that corresponds to the graph and in which each edge is a resistor with resistance equal to a reciprocal of the respective weight for the edge.

To compute the effective resistance feature for a given edge in the graph, the system can computing a respective commute time feature for the edge (as described below with reference to FIG. 4) and divide the respective commute time by the product of a constant, e.g., 2, and a sum of the respective weights for the edges in the graph.

As another example, the one or more affinity features can include a resistive embedding for each of one or more of the nodes in the graph.

The resistive embedding is an embedding that is defined such that a distance between the respective resistive embeddings of any pair of nodes in the graph is an estimate of an effective resistance between the pair of nodes in a circuit that corresponds to the graph and in which each edge is a resistor with resistance equal to a reciprocal of the respective weight for the edge.

In some implementations, the resistive embedding rᵥ for a node v in the graph is equal to:

rᵥ=c^{1/2}BL^{PI}1ᵥ,

where C is an m×m conductance matrix for the graph, m is the number of edges in the graph, C is a diagonal matrix with Cᵢᵢ being the value of the weight for the i-th edge in the graph, B is an edge-node incidence matrix for the graph, L^{PI} is a pseudo-inverse of the graph laplacian L of the graph, 1ᵥ is an n-dimensional vector specifying the indicator for node v, and n is the total number of nodes in the graph.

When the graph has m edges and n nodes, the edge-node incidence matrix is an m×n matrix whose i-th row corresponds to the i-th edge and has a +1 in the u-th column, a −1 in the v-th column and a 0 in all other columns, where u is the index of the first node for the i-th edge and v is the index of the second node.

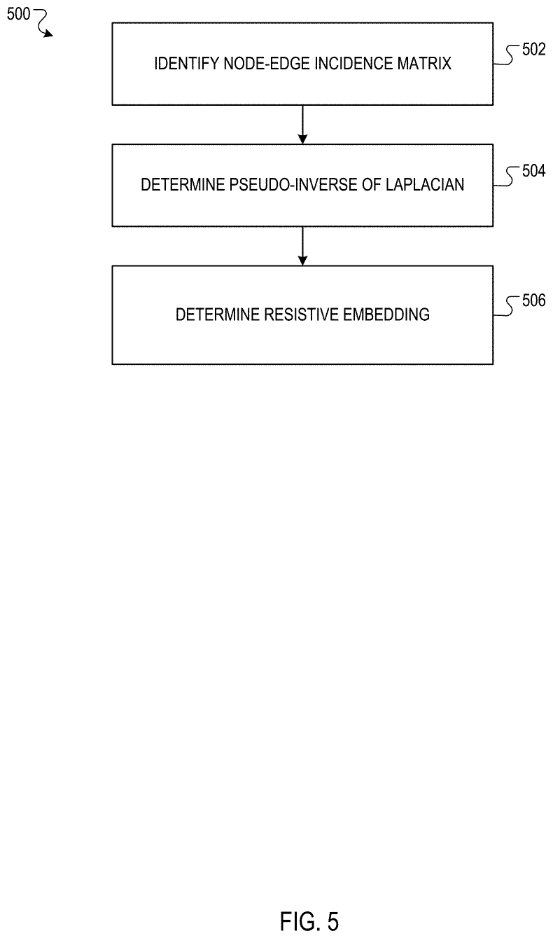

This results in an m-dimensional embedding. Because m can be large, e.g., for large, dense graphs, a technique for computing a resistive embedding with reduced dimensionality and, therefore, reduced storage and compute requirements can be employed. An example of such a technique for computing the resistive embedding for a given node is described in more detail below with reference to FIG. 5.

The system processes the graph data using a graph neural network that is conditioned on the one or more affinity features to generate a task prediction for a machine learning task for the input graph (step 206). As described above, the system can modify the graph data using the affinity features to generate modified graph data and then process the modified graph data using the graph neural network. Alternatively or in addition, the system can modulate the message passing performed by one of the graph neural network layers of the graph neural network using one or more of the affinity features.

FIG. 3 is a flow diagram of an example process 300 for generating a hitting time feature for a given edge. For convenience, the process 300 will be described as being performed by a system of one or more computers located in one or more locations. For example, a graph processing system, e.g., the graph processing system 100 of FIG. 1, appropriately programmed in accordance with this specification, can perform the process 300.

The system computes a respective resistive embedding for each node in the graph (step 302). Computing resistive embeddings for nodes in the graph is described above and will be described in more detail below with reference to FIG. 5.

The system computes a weighted sum of the respective resistive embeddings, with each resistive embedding being weighted by a probability assigned to the corresponding node in a stationary distribution of random walks through the graph (step 304). In particular, the probability assigned to a given node by the stationary distribution is equal to the weighted degree of the given node divided by 2M, where M is the sum of edge weights for the edges in the graph. The weighted degree of a given node is the sum of the wedge weights for edges that are incident to the given node.

The system computes an inner product between (i) a difference between the resistive embedding for the second node in the respective pair connected by the given edge and the resistive embedding for the first node in the respective pair connected by the give edge and (ii) a difference between the resistive embedding for the second node in the respective pair connected by the given edge and the weighted sum of the respective resistive embeddings (step 306).

The system determines the respective hitting time feature for the edge from the inner product (step 308). For example, the respective hitting time feature can be equal to 2M multiplied by the inner product.

FIG. 4 is a flow diagram of an example process 400 for generating a commute time feature for a given edge. For convenience, the process 400 will be described as being performed by a system of one or more computers located in one or more locations. For example, a graph processing system, e.g., the graph processing system 100 of FIG. 1, appropriately programmed in accordance with this specification, can perform the process 400.

The system computes a first hitting time feature for the edge that represents an expected number of steps for a random walk starting at the first node in the respective pair connected by the edge to hit the second node in the respective pair connected by the edge, e.g., as described above with reference to FIG. 3 (step 402).

The system computes a second hitting time feature for the edge that represents an expected number of steps for a random walk starting at the second node in the respective pair connected by the edge to hit the first node in the respective pair connected by the edge, e.g., as described above with reference to FIG. 3 (step 404).

The system computes the respective commute time feature for the edge from the first and second hitting time features (step 406). For example, the commute time can be the sum of the first and second hitting time features.

FIG. 5 is a flow diagram of an example process 500 for determining respective resistive embeddings for the nodes of the graph. For convenience, the process 500 will be described as being performed by a system of one or more computers located in one or more locations. For example, a graph processing system, e.g., the graph processing system 100 of FIG. 1, appropriately programmed in accordance with this specification, can perform the process 500.

The system identifies an edge-node incidence matrix for the graph (step 502). As described above, when the graph has m edges and n nodes, the incidence matrix is an m×n matrix whose i-th row corresponds to the i-th edge and has a +1 in the u-th column, a −1 in the v-th column and a 0 in all other columns, where u is the index of the first node for the i-th edge and v is the index of the second node.

The system determines a pseudo-inverse of a graph Laplacian matrix for the graph (step 504). The graph Laplacian matrix is a matrix L such that L=D−A=B^{T}CB, where D is a diagonal n×n matrix that has Dᵥᵥ equal to the weighted degree of node v for all v in the graph, A is the graph adjacency matrix, and B and C are defined as above.

The system determines the respective resistive embedding for each of the plurality of nodes from the edge-node incidence matrix for the graph and the pseudo-inverse of the graph Laplacian matrix for the graph (step 506). For example, the system can generate a matrix of the resistive embeddings by determining a matrix product between (i) a dimensionality reducing matrix with randomly chosen values, (ii) the edge-node incidence matrix for the graph and (iii) the pseudo-inverse of the graph Laplacian matrix for the graph. For example, the dimensionality reducing matrix can be a k×m matrix with entries independently sampled from a Gaussian distribution and k being an input to the system that specifies how much dimensionality is reduced relative to computing the embeddings using the equation above.

As a particular example, the resistive embedding \hat{r}ᵥ for a node v in the graph can be equal to:

$${\hat{r}}_{v} = \frac{1}{\sqrt{k}} \prod {BL}^{PI} {1}_{v} ,$$

where Π is the dimensionality reducing matrix and B, L^{PI}, and 1ᵥ are defined as above.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers, the method comprising
obtaining graph data representing an input graph that comprises a set of nodes and a set of edges that each connect a respective pair of nodes, the graph data comprising respective node features for each of the nodes, edge features for each of the edges, and a respective weight for each of the edges;
generating one or more affinity features, each affinity feature representing a property of one or more random walks through the graph guided by the respective weights for the edges; and
processing the graph data using a graph neural network that is conditioned on the one or more affinity features to generate a task prediction for a machine learning task for the input graph.

2. The method of claim 1, wherein the one or more features comprise a respective hitting time feature for each of one or more of the edges in the graph that represents an expected number of steps for a random walk starting at a first node in the respective pair connected by the edge to hit a second node in the respective pair connected by the edge.

3. The method of claim 2, further comprising:
computing the respective hitting time feature for each of the one or more edges, comprising:
computing a respective resistive embedding for each node in the graph;
computing a weighted sum of the respective resistive embeddings, wherein each resistive embedding is weighted by a probability assigned to the corresponding node in a stationary distribution of random walks through the graph;
for each of the one or more edges:
computing an inner product between (i) a difference between the resistive embedding for the second node in the respective pair connected by the edge and the resistive embedding for the first node in the respective pair connected by the edge and (ii) a difference between the resistive embedding for the second node in the respective pair connected by the edge and the weighted sum of the respective resistive embeddings; and
determining the respective hitting time feature for the edge from the inner product.

4. The method of claim 1, wherein the one or more features comprise a respective commute time feature for each of one or more of the edges in the graph that represents an expected number of steps for a random walk starting at a first node in the respective pair connected by the edge to reach a second node in the respective pair connected by the edge and then return to the first node in the respective pair connected by the edge.

5. The method of claim 4, further computing the respective commute time feature for each of the one or more edges, comprising for each of the one or more edges:
computing a first hitting time feature for the edge that represents an expected number of steps for a random walk starting at the first node in the respective pair connected by the edge to hit the second node in the respective pair connected by the edge;
computing a second hitting time feature for the edge that represents an expected number of steps for a random walk starting at the second node in the respective pair connected by the edge to hit the first node in the respective pair connected by the edge; and
computing the respective commute time feature for the edge from the first and second hitting time features.

6. The method of claim 1, wherein the one or more affinity features comprise an effective resistance feature for each of one or more of the edges in the graph that represents an effective resistance between a first node in the respective pair connected by the edge and a second node in the respective pair connected by the edge in a circuit that corresponds to the graph and in which each edge is a resistor with resistance equal to a reciprocal of the respective weight for the edge.

7. The method of claim 6, further computing the respective effective resistance feature for each of the one or more edges, comprising for each of the one or more edges:
computing a respective commute time feature for the edge; and
dividing the respective commute time by the product of a constant and a sum of the respective weights for the edges in the graph.

8. The method of claim 1, wherein the one or more affinity features comprise a resistive embedding for each of one or more of the nodes in the graph.

9. The method of claim 8, wherein a distance between the respective resistive embeddings of any pair of nodes in the graph is an estimate of an effective resistance between the pair of nodes in a circuit that corresponds to the graph and in which each edge is a resistor with resistance equal to a reciprocal of the respective weight for the edge.

10. The method of claim 8, further comprising computing the respective resistive embeddings for each of the plurality of nodes in the graph, comprising:
determining the respective resistive embedding for each of the plurality of nodes from an edge-node incidence matrix for the graph and a pseudo-inverse of a graph Laplacian matrix for the graph.

11. The method of claim 10, wherein determining the respective resistive embedding for each of the plurality of nodes comprises determining a matrix product between (i) a dimensionality reducing matrix with randomly chosen values, (ii) the edge-node incidence matrix for the graph and (iii) the pseudo-inverse of the graph Laplacian matrix for the graph.

12. The method of claim 1, wherein processing the graph data using a graph neural network that is conditioned on the one or more affinity features to generate a task prediction for a machine learning task for the input graph comprises:
generating modified graph data by modifying the node features, the edge features, or both using the one or more affinity features; and
processing the modified graph data using the graph neural network to generate the task prediction.

13. The method of claim 1, wherein the graph data further comprises graph-level features of the input graph.

14. One or more non-transitory computer storage media storing instructions that when executed by one or more computers cause the one or more computers to perform operations comprising:
obtaining graph data representing an input graph that comprises a set of nodes and a set of edges that each connect a respective pair of nodes, the graph data comprising respective node features for each of the nodes, edge features for each of the edges, and a respective weight for each of the edges;
generating one or more affinity features, each affinity feature representing a property of one or more random walks through the graph guided by the respective weights for the edges; and
processing the graph data using a graph neural network that is conditioned on the one or more affinity features to generate a task prediction for a machine learning task for the input graph.

15. A system comprising:
one or more computers; and
one or more storage devices communicatively coupled to the one or more computers, wherein the one or more storage devices store instructions that, when executed by the one or more computers, cause the one or more computers to perform operations comprising:
obtaining graph data representing an input graph that comprises a set of nodes and a set of edges that each connect a respective pair of nodes, the graph data comprising respective node features for each of the nodes, edge features for each of the edges, and a respective weight for each of the edges;
generating one or more affinity features, each affinity feature representing a property of one or more random walks through the graph guided by the respective weights for the edges; and
processing the graph data using a graph neural network that is conditioned on the one or more affinity features to generate a task prediction for a machine learning task for the input graph.

16. The system of claim 15, wherein the one or more features comprise a respective hitting time feature for each of one or more of the edges in the graph that represents an expected number of steps for a random walk starting at a first node in the respective pair connected by the edge to hit a second node in the respective pair connected by the edge.

17. The system of claim 16, the operations further comprising:
computing the respective hitting time feature for each of the one or more edges, comprising:
computing a respective resistive embedding for each node in the graph;
computing a weighted sum of the respective resistive embeddings, wherein each resistive embedding is weighted by a probability assigned to the corresponding node in a stationary distribution of random walks through the graph;
for each of the one or more edges:
computing an inner product between (i) a difference between the resistive embedding for the second node in the respective pair connected by the edge and the resistive embedding for the first node in the respective pair connected by the edge and (ii) a difference between the resistive embedding for the second node in the respective pair connected by the edge and the weighted sum of the respective resistive embeddings; and
determining the respective hitting time feature for the edge from the inner product.

18. The system of claim 15, wherein the one or more features comprise a respective commute time feature for each of one or more of the edges in the graph that represents an expected number of steps for a random walk starting at a first node in the respective pair connected by the edge to reach a second node in the respective pair connected by the edge and then return to the first node in the respective pair connected by the edge.

19. The system of claim 18, the operations further computing the respective commute time feature for each of the one or more edges, comprising for each of the one or more edges:
computing a first hitting time feature for the edge that represents an expected number of steps for a random walk starting at the first node in the respective pair connected by the edge to hit the second node in the respective pair connected by the edge;
computing a second hitting time feature for the edge that represents an expected number of steps for a random walk starting at the second node in the respective pair connected by the edge to hit the first node in the respective pair connected by the edge; and
computing the respective commute time feature for the edge from the first and second hitting time features.

20. The system of claim 15, wherein the one or more affinity features comprise an effective resistance feature for each of one or more of the edges in the graph that represents an effective resistance between a first node in the respective pair connected by the edge and a second node in the respective pair connected by the edge in a circuit that corresponds to the graph and in which each edge is a resistor with resistance equal to a reciprocal of the respective weight for the edge.
